(19) United States
(12) Patent Application Publication
(10) Pub. No.: US 2006/0015509 A1
(43) Pub. Date: Jan. 19, 2006

(54) Bookmark management apparatus for dynamic categorization

(75) Inventor: Masaya Naitou, Kawasaki (JP)

Correspondence Address: Patrick G.. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/232,680

(22) Filed: Sep. 22, 2005

Related U.S. Application Data
(63) Continuation of application No. PCT/JP03/09035, filed on Jul. 16, 2003.

(51) Int. Cl. G06F 17/30

(52) U.S. Cl. 707/10

(57) ABSTRACT

A category name stored in a bookmark of a Web browser and a related keyword relating to the category name and set by a user are stored in a category database. A URL, the contents text of a Web page of the URL, and the related keyword assigned by the user are stored in URL information data. When the user performs a bookmark tracing operation, a category is selected from among the category names of the category database. Using the related keyword corresponding to the category, the contents text of the URL information database, the related keyword, or both of them are retrieved, and the URL corresponding to a hit object is presented to the user.

### CROSS REFERENCE TO RELATED APPLICATION

This application is a continuation of international PCT application No. PCT/JP2003/009035 filed on Jul. 16, 2003.

### BACKGROUND OF THE INVENTION

1. Field of the Invention

The present invention relates to a URL information storage apparatus and method for appropriately categorizing URL information in the bookmark facility for storing URL information (uniform resource locator) about a Web page.

2. Description of the Related Art

Recently, the number of Web pages on the Internet and the Intranet has been rapidly increasing, and it is predicted that the Web pages will continuously increase in the future. With the increasing number of pages, there is also an increasing number of Web pages to be processed with a bookmark facility.

Currently a bookmark stores a URL indicating the position of a Web page. To easily detect a URL in an increasing number of URLs, a user can generate a category and put a URL page in an appropriate category.

In the conventional bookmark facility, a user generates a category, and determines in which category a Web page is to be stored when a bookmark is applied to the Web page. Therefore, a user sometimes cannot easily determine in which category a Web page is to be stored, or cannot remember in which category the Web page is stored when it is referenced. In addition, unless a Web page is put in a category, bookmarks are not well managed and the bookmark facility does not effectively work. Furthermore, when a Web page is included in a category, and when it is to be included in a plurality of categories, the URL information is copied and recorded the number of times equal to the number of categories in which the information is included.

It is also necessary to re-categorize the information when the contents of a Web page to which a bookmark is applied are changed and are not consistent with the category.

To solve the above-mentioned problem, in the patent documents 1 and 2, when a URL is added to a bookmark, a keyword associated with a category is matched with the contents of a page, or a URL is recorded subordinate to an appropriate category by using a keyword for use in retrieval. However, in these methods, the following problems cannot be solved.
When a category or a keyword associated with the configuration of a category is changed, the URL belonging to the category does nor reflect the status after the change.
When the contents of a URL page to which a bookmark is applied are changed, the category is not associated with the actual page.
   Patent Document 1

Japanese Patent Application Publication No. Hei 11-167580

Patent Document 2

Japanese Patent Application Publication No. 2000-20536

### SUMMARY OF THE INVENTION

The present invention aims at providing an apparatus capable of appropriately managing a number of bookmarks.

The bookmark management apparatus according to the present invention includes: a first record device for storing location information about a Web page together with the text contents of the Web page and a keyword relating to the contents of the Web page; a second record device for storing the name of the category of a bookmark for use in managing a Web page together with a keyword relating to the category; and a retrieval/categorization device for retrieving the text contents and/or the keyword relating to the contents of the Web page using the keyword relating to the category when a user specifies the category, thereby defining the Web page obtained as a result of retrieval as a Web page belonging to the category.

According to the present invention, the relationship between the category of a bookmark and the location information (for example, a URL) about a Web page is dynamically defined using a keyword. Therefore, it is not necessary for a user to manually arrange a large number of pieces of location information. In addition, a keyword of a category is matched with a keyword assigned to a Web page by a user and/or the text contents of the Web page, thereby categorizing the Web pages in consideration with the intention of a user and/or the intention of a generator of the Web page. Especially, when a Web page is updated, the Web page can be appropriately categorized according to the latest information by updating the stored text contents.

### BRIEF DESCRIPTION OF THE DRAWINGS

FIG. 1 shows the basic configuration of an embodiment of the present invention;

FIG. 2 is an explanatory view of the configuration of a program realizing an embodiment of the present invention;

FIG. 3 shows the screen displaying a categorized bookmark;

FIG. 4 shows an example of the data structure according to an embodiment of the present invention;

FIG. 5 is a flowchart of the flow of the process from selecting a bookmark according to an embodiment of the present invention to displaying a Web page of a URL;

FIG. 6 is a flowchart of the flow of the process performed when the contents of a Web page are updated according to an embodiment of the present invention;

FIGS. 7 and 8 show display examples of bookmarks when the contents of a Web page are changed; and

FIG. 9 shows an example of a URL information database storing the history of the changes of text contents of a Web page.

### DESCRIPTION OF THE PREFERRED EMBODIMENTS

The present invention provides a bookmark management method requiring no categorizing operation and no arrangement of bookmarks when a bookmark is applied to a Web page.

The present invention also provides a method not requiring an operation of copying the URL information when URL information is to be included in a plurality of categories, or requiring no re-categorizing operation when a user changes the category configuration or the contents of a Web page to which a bookmark is applied are changed.

Practically, in the management of a bookmark, category information and URL information are separately managed without any relation to each other. However, the URL information is stored not only with the URL, but also with the text contents of the page, and an added keyword assigned by a user. When an operation of tracing a category tree to reference a bookmark is actually performed, the stored contents of a Web page are retrieved using a keyword associated with a category, a URL corresponding to an added keyword including a matching character string or text contents is dynamically associated with a URL associated with the category, and the URL is displayed.

An aspect of an embodiment of the present invention has a device capable of displaying the categorization reflecting an intention of a bookmark user and the categorization reflecting an intention of a Web page generator by switching between them by retrieving only a keyword added by a user or retrieving only the text contents of a Web page. That is, a keyword added by a user implicitly reflects the usage intended by the user for a corresponding URL Web page. Therefore, performing retrieval using an added keyword refers to performing categorization with the intention of a user reflected. The text contents of a Web page implicitly reflect the intention of a generator of the Web page. Therefore, retrieving the text contents of a Web page refers to performing categorization with the intention of a generator of the Web page.

According to another aspect of the present invention a device is included for enabling categorization to be performed depending on the latest contents of a Web page, and to be performed depending on the transition of the contents of a Web page with time.

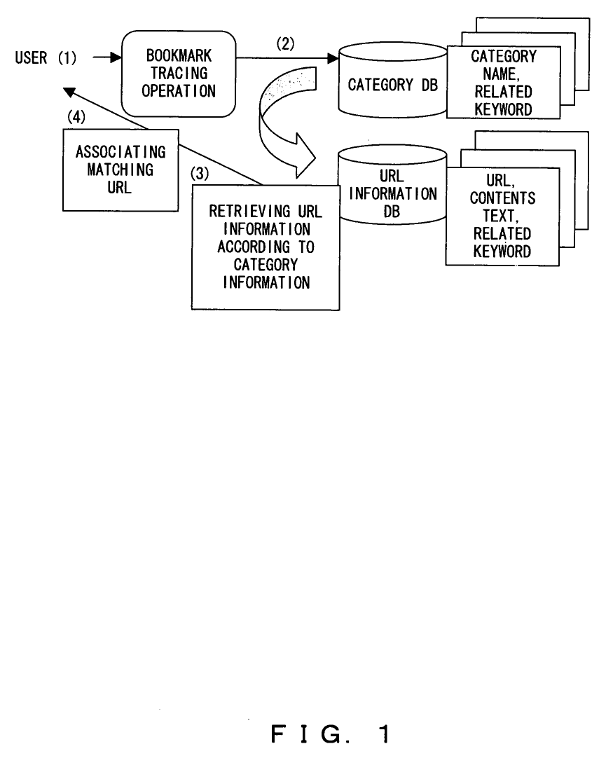

FIG. 1 shows the basic configuration of an embodiment of the present invention.

In FIG. 1, when the user operating the bookmark selects a category and references a URL belonging to the category (1), the name of the category or a keyword associated with the category is used (2), the text contents of the Web page stored in the URL information or the associated keyword is retrieved (3), and the URL matching the keyword is presented to the user as a URL associated with the category (4). By dynamically generating a URL belonging to a category, it is not necessary to arrange bookmarks.

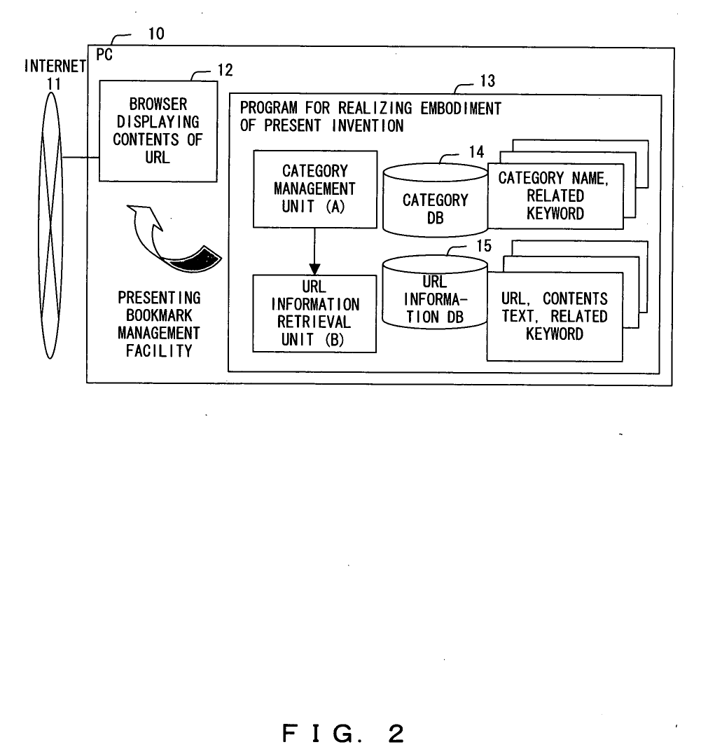

FIG. 2 is an explanatory view of the configuration of a program realizing an embodiment of the present invention.

In an embodiment of the present invention, it is assumed that a browser 12 is incorporated into a PC 10 connected to the Internet 11. A program 13 according to the embodiment is included in the configuration.

When a user selects a category using a browser, a category management unit (A) obtains a keyword corresponding to the category from a category database 14, and passes the keyword to a URL information retrieval unit (B). The URL information retrieval unit (B) checks on all URL information whether or not the text contents of a URL information database 15 or a related keyword includes a portion matching the obtained keyword. When a matching one is detected, its URL is displayed on the screen, thereby associating the user-selected category with the URL, and allowing the user to reference a set of URLs belonging to the category.

That is, not only a URL but also text contents of a Web page referred to by the URL are stored as URL information so that they can be used as the information for URL retrieval.

In an aspect of an embodiment of the present invention, when URL information is retrieved, only the text contents are retrieved to define a category which reflects the contents intended by a Web page generator, and only the keyword is retrieved to define a category which reflects the contents intended by a bookmark user. Both of them can also be retrieved.

In another aspect of an embodiment of the present invention, when a Web page of a URL stored in a bookmark is referenced, the text contents of the Web page stored in the URL information can be replaced with the latest contents, thereby enabling the latest information to be used when a URL is associated with a category.

In a further aspect of an embodiment of the present invention, when a Web page of a URL stored in a bookmark is referenced, and the contents are different, the stored text contents of the Web page are not replaced with the latest contents, but version management is performed, and the contents are stored without deletion, thereby preventing the correspondence being lost due to change of the contents when URLs are associated with categories.

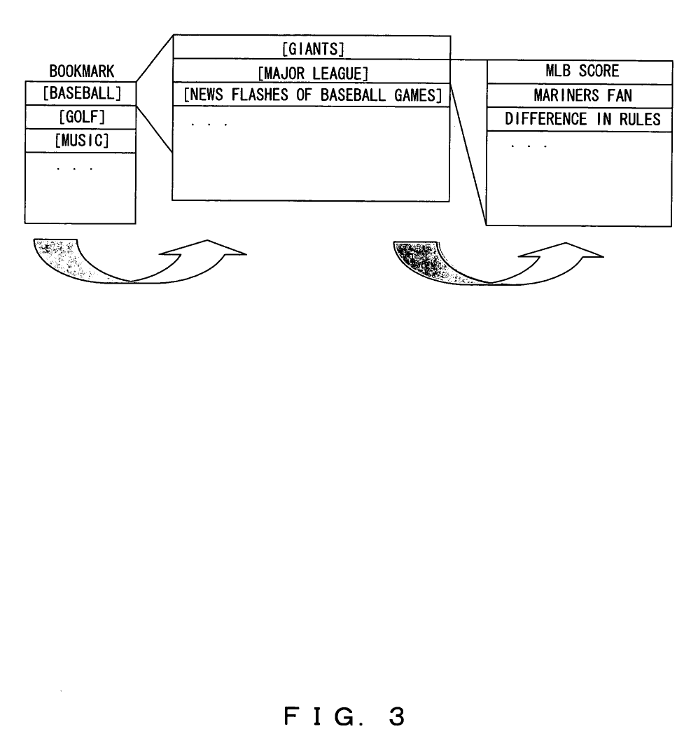

FIG. 3 shows the screen displaying a categorized bookmark.

The menu shown on the right in FIG. 3 is displayed as a bookmark. The menu has folders for baseball, golf, music, etc. When a baseball folder is selected, the lower order folder for the baseball folder is opened. The lower order folder includes folders for Giants, major league, and news flashes of baseball games. When a major league folder is selected, a result of retrieval from URL information using keywords associated with “baseball” and “major league” is displayed. In this example, titles of pages of MLB Scores, Mariners Fans, differences in rules, etc. are displayed.

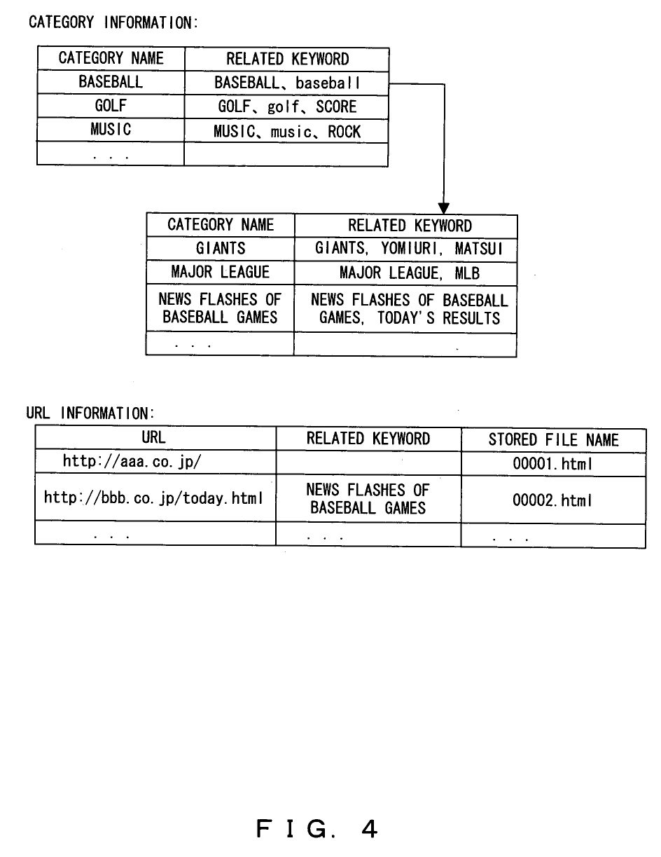

FIG. 4 shows an example of the data structure according to an embodiment of the present invention.

As category information, a category name is associated with a related keyword. The highest order categories are baseball, golf, music, etc. The related keywords of baseball are baseball in Japanese and baseball in English. The related keywords of golf are golf in Japanese, golf in English, and score. The related keywords of music are music in Japanese, music in English, and rock. The lower order categories of the baseball category are Giants, major league, news flashes of baseball games, etc. as category names. The category names of Giants are Giants, Yomiuri, Matsui as related keywords. The category names of the major league are major league and MLB as related keywords. The news flashes of baseball games stores news flashes of baseball games and today's results as related keywords.

In the URL information, each URL is stored as associated with a related keyword and a storage file. A related keyword is optionally set by a user. Some URLs do not have related keywords. A storage file is associated with all URLs, and stores contents text of Web pages indicated by URLs.

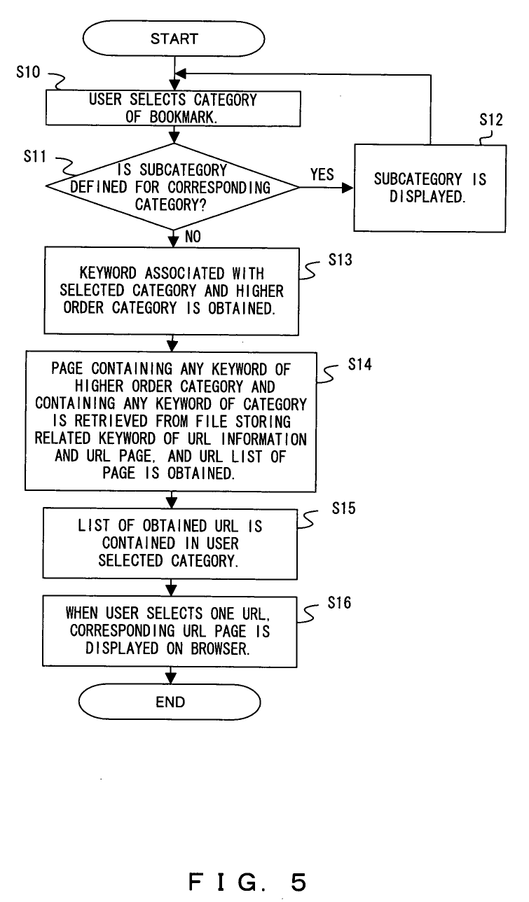

FIG. 5 is a flowchart of the flow of the process from selecting a bookmark to displaying a Web page of a URL according to an embodiment of the present invention.

In step S10, a user selects a category of a bookmark. In step S11, it is determined whether or not the category has a subcategory defined. If the determination in step S11 is YES, the subcategory is displayed (step S12), and control is returned to step S10. If the determination in step S11 is NO, then a selected category and a keyword associated with the higher order category are obtained in step S13. In step S14, a page is searched from the related keyword or the URL information and the file storing the URL page, and the list of the URLs of the page is obtained. When searching for the page, a page containing any keyword of a higher category and any keyword of the category is retrieved in the text retrieval or related keyword retrieval, or both retrieval methods.

In step S15, the URL list obtained in step S14 is displayed as URLs contained in the category selected by a user. In step S16, when a user selects one URL, the page of the URL is displayed on the browser and the process terminates.

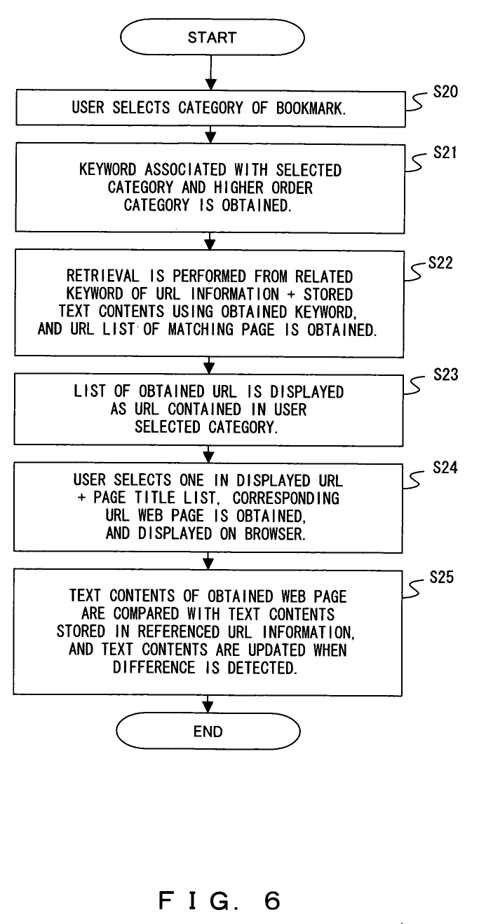

FIG. 6 is a flowchart of the flow of the process performed when the contents of a Web page are updated according to an embodiment of the present invention.

In step S20, a user selects a category. In step S21, a selected category and a keyword associated with the category are obtained. In step S22, retrieval is performed using a keyword obtained in step S21 from the related keyword of the URL information and the stored text contents, and the URL list on the matching page is obtained. In step S23, the URL list obtained in step S22 is displayed as a URL contained in the category selected by the user. In step S24, the user select one of the page titles from the list of the URLs and page titles displayed in step S23, obtains the Web page of the URL, and displays it on the browser. In step S25, the text contents of the Web page obtained in step S24 are compared with the text contents stored in the referenced URL information. If there is any changed portion, the text is updated and the process terminates.

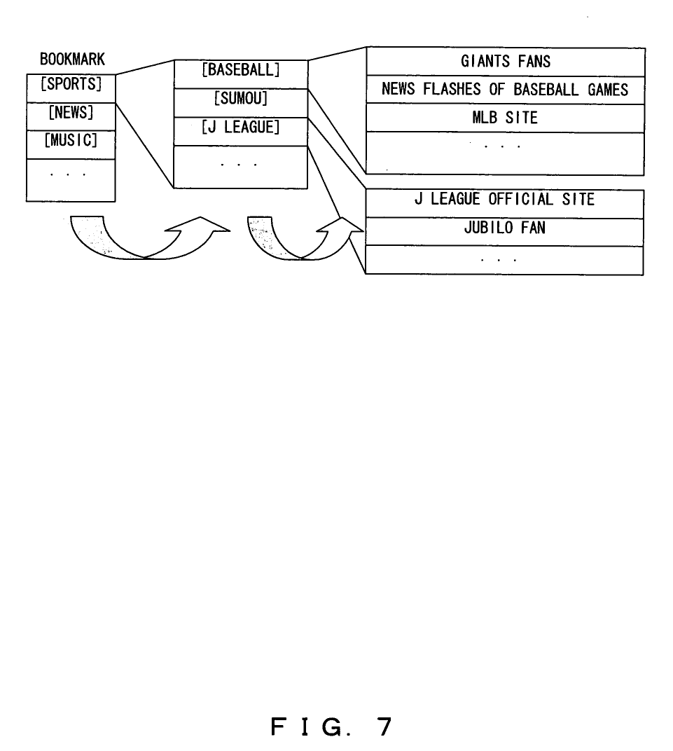

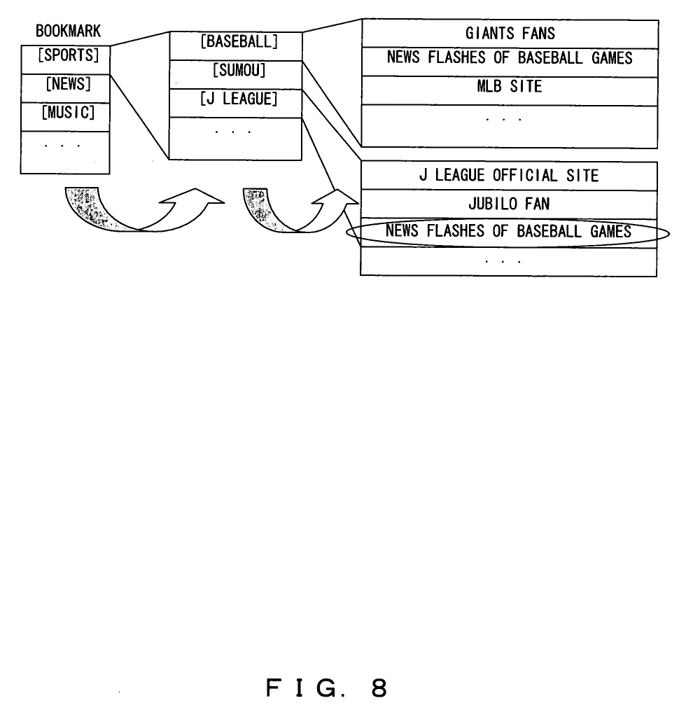

FIGS. 7 and 8 show display examples of bookmarks when the contents of a Web page are changed.

FIGS. 7 and 8 show that the news flashes of Japan professional baseball games presented from April start is also presenting the news flashes of J League football games.

FIG. 7 shows the bookmark at the point in March. The titles of the pages of Giant fans, news flashes of baseball games, MLB site are displayed in the subcategories of baseball below the category of sports, and the page titles of J League official site and Jubilo fans are displayed in the subcategories of J League.

Afterwards, when the categories of baseball and J League are selected in April, the text contents are updated, the information about the J League is added to the page. Therefore, as a result of the retrieval using a keyword of the subcategory of the J League, the site of the news flashes of baseball games indicates a matching result, thereby displaying the page title of the news flashes of baseball games below the category of the J League.

FIG. 8 shows the above operation. Compared with FIG. 7, the matching result is added to the page title included in the subcategory of J League. The URL of the matching result is the same as the URL of the matching result of baseball.

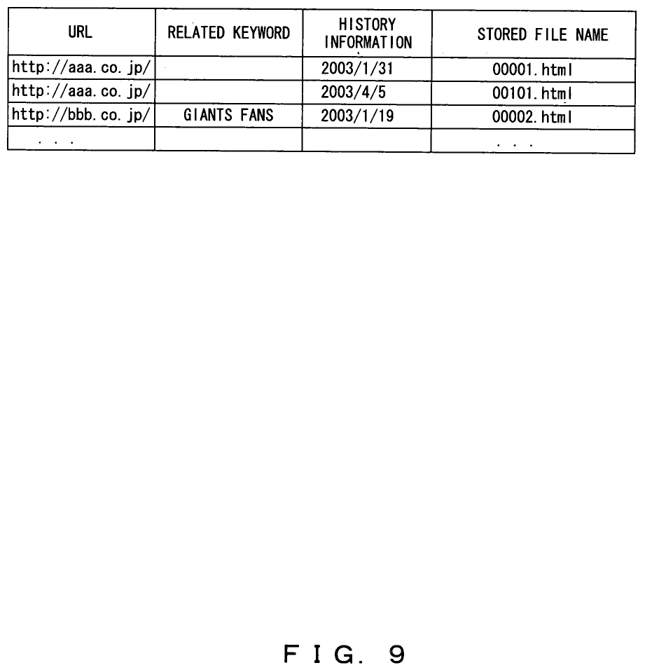

FIG. 9 shows an example of a URL information database storing the history of the changes of text contents of a Web page.

In FIG. 9, new history information is added to the URL information shown in FIG. 4. It has the same URL. However, when it has different text contents, the storage date is set as history information, and additionally stored as associated with the new text contents. By storing the old text contents, the URLs can be protected from being reduced in number when displayed at the time when a category is selected.

As described above, by dynamically associating the category class of a bookmark with a URL belonging to each category, the following advantage can be obtained.
When a URL is stored in a bookmark, no categorizing process is required.
It is not necessary to arrange the URLs belonging to the respective categories.
Since a URL is contained in a plurality of categories, it is not necessary to store the URL in a bookmark plural times.
By updating the text contents when a Web page is referenced, no re-categorizing process is required even if the contents of the Web page are converted and category classification becomes inappropriate.
Although a category is added or deleted, no re-categorizing process is required.
   In addition, since category classification depends on the interest of a person, it is hardly shared with other persons. However, since URL information relates to useful pages, a plurality of persons can share the information. For example, when an operation is performed in cooperation, the useful pages for the operation can be shared among the cooperative workers. In this case, since URLs are dynamically associated when a category is traced, only URL information is shared, and a person has to manage only the category information (it can be considered that a link page by an expert can be dynamically fetched to the user bookmark).

What is claimed is:

1. A bookmark management apparatus, comprising:
a first record unit storing location information about a Web page together with text contents of the Web page and a keyword relating to contents of the Web page;
a second record unit storing a name of a category of a bookmark for use in managing the Web page together with the keyword relating to the category; and
a retrieval/categorization unit retrieving the text contents and/or the keyword relating to the contents of the Web page using the keyword relating to the category when a user specifies the category,
thereby defining a Web page obtained as a result of retrieval as a Web page belonging to the category.

2. The apparatus according to claim 1, wherein the retrieval/categorization unit comprises a switch unit switching among search on the text contents, search on keywords related to the Web page contents and both of the text contents search and the keyword search.

3. The apparatus according to claim 1, wherein when the Web page recorded in the bookmark management apparatus is accessed, and when the text contents of the Web page are different from the stored text contents, the already stored text contents are updated with new text contents.

4. The apparatus according to claim 1, wherein when the text contents are stored, information indicating freshness of the text contents such as date of storage is stored as well and if the text contents of a Web page is different from a stored text contents, the information indicating freshness are updated as well as the text contents being updated with a stored new text contents.

5. A bookmark managing method, comprising:
storing location information about a Web page together with text contents of the Web page and a keyword relating to contents of the Web page;
storing a name of a category of a bookmark for use in managing the Web page together with the keyword relating to the category; and
retrieving the text contents and/or the keyword relating to the contents of the Web page using the keyword relating to the category when a user specifies the category, thereby defining a Web page obtained as a result of retrieval as a Web page belonging to the category.

6. The method according to claim 5, wherein the retrieving/categorizing step comprises switching among search on the text contents, search on keywords related to the Web page contents and both of the text contents search and the keyword search.

7. The method according to claim 5, wherein when the recorded Web page is accessed, and when the text contents of the Web page are different from the stored text contents, the already stored text contents are updated with new text contents.

8. The method according to claim 5, wherein when the text contents are stored, information indicating freshness of the text contents such as date of storage is stored as well and if the text contents of a Web page is different from a stored text contents, the information indicating freshness are updated as well as the text contents being updated with a stored new text contents.

9. A program used to direct an information processing device to realize a bookmark managing method, comprising:
storing location information about a Web page together with text contents of the Web page and a keyword relating to contents of the Web page;
storing a name of a category of a bookmark for use in managing the Web page together with the keyword relating to the category; and
retrieving the text contents and/or the keyword relating to the contents of the Web page using the keyword relating to the category when a user specifies the category, thereby defining a Web page obtained as a result of retrieval as a Web page belonging to the category.
